(19) United States
(12) Patent Application Publication
(10) Pub. No.: US 2019/0070614 A1
(43) Pub. Date: Mar. 7, 2019

(54) CONE MILLS

(71) Applicant: Process Components Limited, Poynton (GB)

(72) Inventors: Anthony Goodwin, Cheshire (GB); Mark Emery, Cheshire (GB)

(21) Appl. No.: 16/101,172

(22) Filed: Aug. 10, 2018

(30) Foreign Application Priority Data
Sep. 4, 2017 (GB) 1714114.4

(51) Int. Cl. B02C 13/30; B02C 13/18; B02C 23/16

(52) U.S. Cl. CPC B02C 13/30; B02C 2023/165; B02C 23/16; B02C 13/18

(57) ABSTRACT

A cone mill comprises a rotating tool for moving friable material across a static conical screen. The tool is driven to rotate by a tool drive shaft. The mill includes a motor, the motor causing rotation of a motor drive shaft. The tool drive shaft and the motor drive shaft are located an angle with respect to each other and the mill comprises a universal joint for transferring rotary motion from the motor through the angle to the tool.

### CROSS REFERENCE TO RELATED APPLICATIONS

This application claims the priority of Great Britain Patent Application No. 1714114.4 titled “IMPROVEMENTS IN OR RELATING TO CONE MILLS,” filed Sep. 4, 2017, the contents of which are hereby incorporated by reference.

### BACKGROUND OF THE INVENTION

A cone mill (or conical screen mill) is a machine used to reduce the size of material in a uniform manner. It is an alternative to the hammermill or other forms of grinding mills.

The mill operates by having the product fed in by gravity or vacuum. A rotating tool such as an impeller forces the material outward to a conical screen surface, where it is sized and passed through the openings in the screen. Once finished, the product drops through the milling chamber to a receptacle underneath.

Cone mills come in a variety of sizes from table top lab models to full-size high-capacity machines for use in processing large quantities of material, and the impeller and screen can be customized for each individual use. The machines can be used not only to reduce the size of particles, but also for deagglomeration, sieving, dispersion, and mixing.

The applications for a cone mill are varied, but trend towards use in the food, cosmetic, chemical, and pharmaceutical industries.

In many cases, often for reasons of size, a motor for causing rotation of the tool is positioned at an angle, for example at 90 degrees. This means that it is necessary to transfer rotary motion through the angle.

It is known to use a gear linkage to transfer the rotary motion between two drive shafts. However, gear linkages place limitations on the maximum speed at which the tool can be driven to rotate and also suffer from high levels of heat and noise generation.

The present invention seeks to address the problems with known cone mills.

### SUMMARY OF THE INVENTION

According to an aspect of the present invention there is provided a cone mill comprising a rotating tool for moving friable material across a static conical screen, the tool being driven to rotate by a tool drive shaft, the mill includes a motor, the motor causing rotation of a motor drive shaft, the tool drive shaft and the motor drive shaft being located an angle with respect to each other, the mill comprising a universal joint for transferring rotary motion from the motor through the angle to the tool.

In some embodiments the universal joint is a double universal joint.

The angle through which rotary motion is transferred may be in the range 90° to 125°, for example approximately 90°.

The universal joint may comprise two Cardan-style universal joints. In some embodiments each of these joints provide approximately 45° of rotary angle.

In some embodiments the rotating tool is mounted generally vertically. This would allow product to be fed from above into the cone. In use, for example, the tool drive shaft may be generally vertical and the motor drive shaft may be generally horizontal.

In some embodiments the tool is a beater. The beater may, for example, include one or more arms mounted so as to be generally parallel to the screen.

The cone diameter may, for example, be approximately: 680 mm, 540 mm, 340 mm, 220 mm, 170 mm, 120 mm or 75 mm.

A further aspect provides a pharmaceutical powder milling machine comprising a cone mill as described herein.

A further aspect provides a cone mill comprising a rotating tool for moving friable material across a static conical screen, the tool being driven to rotate by a tool drive shaft, the mill includes a motor, the motor causing rotation of a motor drive shaft, the tool drive shaft and the motor drive shaft being located at an approximately 90 degree angle with respect to each other, the mill comprising a gearless joint for transferring rotary motion from the motor through the angle to the tool, said gearless joint comprising a double universal joint having a first joint and a second joint, each of said joints providing approximately 45 degrees of rotary angle of said 90 degrees between said motor drive shaft and said tool drive shaft.

The first and second joints may be Cardan-style universal joints.

The first and second joints may be mounted back-to-back with a center yoke, said first joint being connected, directly or indirectly, to said motor drive shaft, said second joint being connected, directly or indirectly, to said tool drive shaft.

Different aspects and embodiments of the invention may be used separately or together.

Further particular and preferred aspects of the present invention are set out in the accompanying independent and dependent claims. Features of the dependent claims may be combined with the features of the independent claims as appropriate, and in combinations other than those explicitly set out in the claims.

### BRIEF DESCRIPTION OF THE DRAWINGS

The present invention will now be more particularly described, by way of example, with reference to the accompanying drawings, in which:

FIG. 1a shows a side view of a cone mill formed in accordance with the present invention;

FIG. 1b shows a top view of a cone mill formed in accordance with the present invention;

FIG. 1c shows a bottom view of a cone mill formed in accordance with the present invention;

FIG. 1d shows a front view of a cone mill formed in accordance with the present invention;

FIG. 2 is a section of FIG. 1a;

FIG. 3 is an exploded view of the mill of FIGS. 1 and 2;

FIG. 4 is a magnified exploded view of the conical screen and beater assembly forming part of the mill of FIGS. 1 to 3;

FIG. 5 is a magnified exploded view of a beater shaft assembly;

FIG. 6 is a magnified exploded view of part of a milling chamber and a drive shaft assembly;

FIG. 7 is an exploded view of a motor housing and motor stool;

FIG. 8a illustrates the structure and functioning of a joint which couples the drive and tool shafts of the mill;

FIG. 8b illustrates the structure and functioning of a joint which couples the drive and tool shafts of the mill; and

FIG. 9 is a parts list which also relates to reference numerals used in FIGS. 1 to 8b.

### DETAILED DESCRIPTION OF THE PREFERRED EMBODIMENTS

The example embodiments are described in sufficient detail to enable those of ordinary skill in the art to embody and implement the systems and processes herein described. It is important to understand that embodiments can be provided in many alternative forms and should not be construed as limited to the examples set forth herein.

Accordingly, while embodiments can be modified in various ways and take on various alternative forms, specific embodiments thereof are shown in the drawings and described in detail below as examples. There is no intent to limit to the particular forms disclosed. On the contrary, all modifications, equivalents, and alternatives falling within the scope of the appended claims should be included. Elements of the example embodiments are consistently denoted by the same reference numerals throughout the drawings and detailed description where appropriate.

Unless otherwise defined, all terms (including technical and scientific terms) used herein are to be interpreted as is customary in the art. It will be further understood that terms in common usage should also be interpreted as is customary in the relevant art and not in an idealized or overly formal sense unless expressly so defined herein.

In the following description, all orientational terms, such as upper, lower, vertical, horizontal, radially and axially, are used in relation to the drawings and should not be interpreted as limiting on the invention.

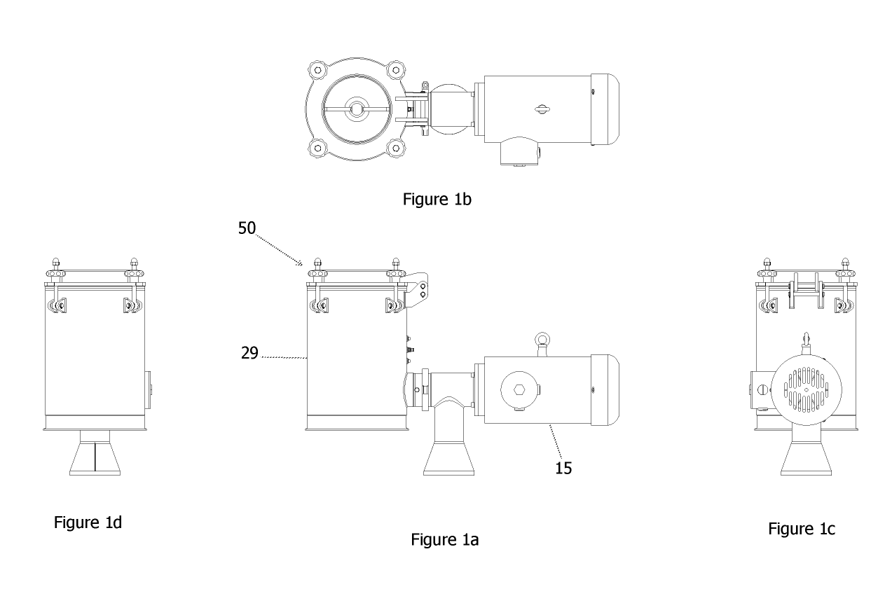

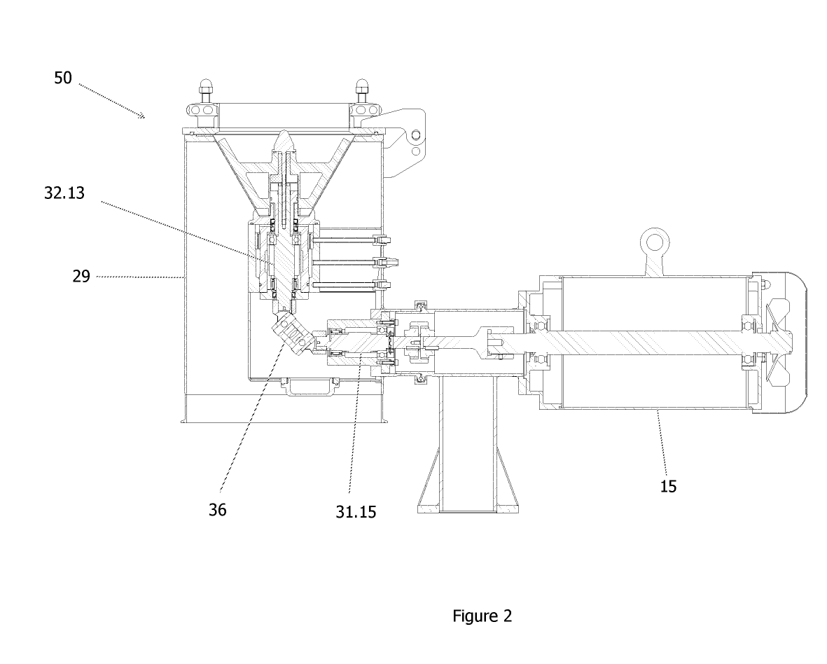

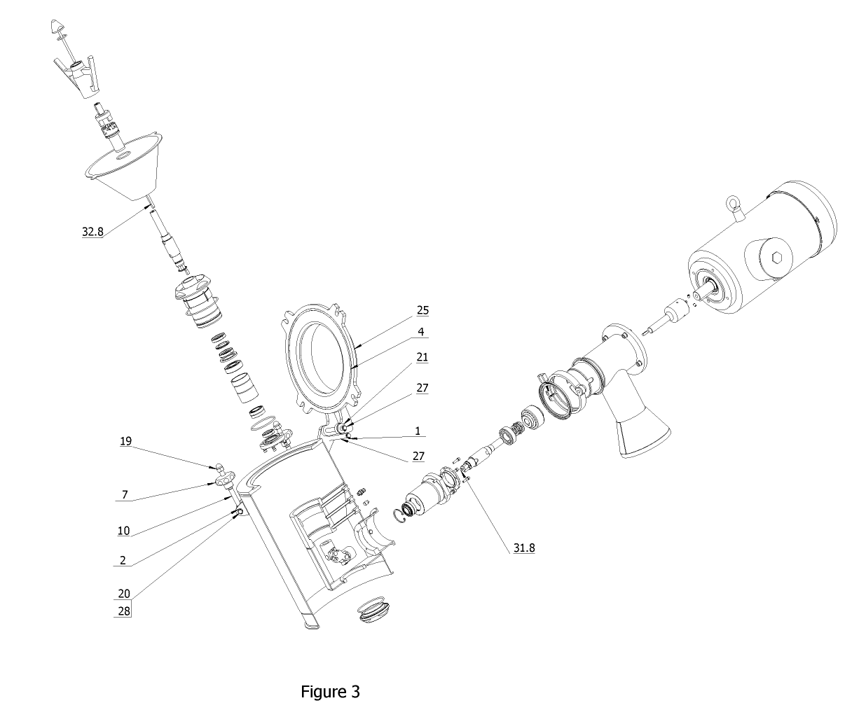

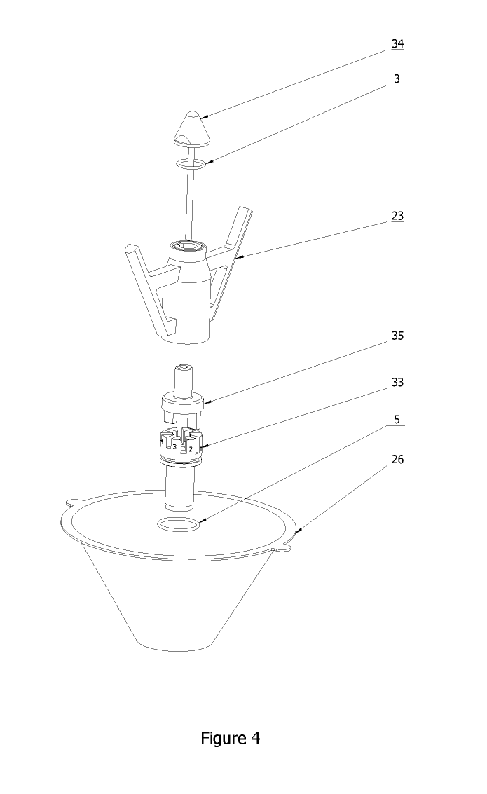

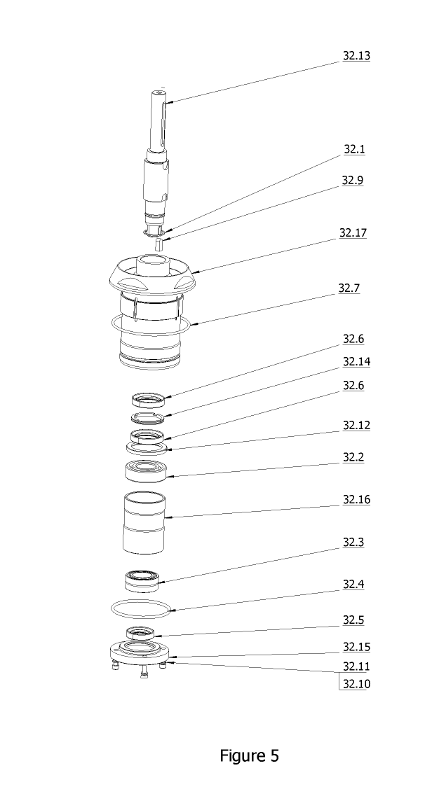

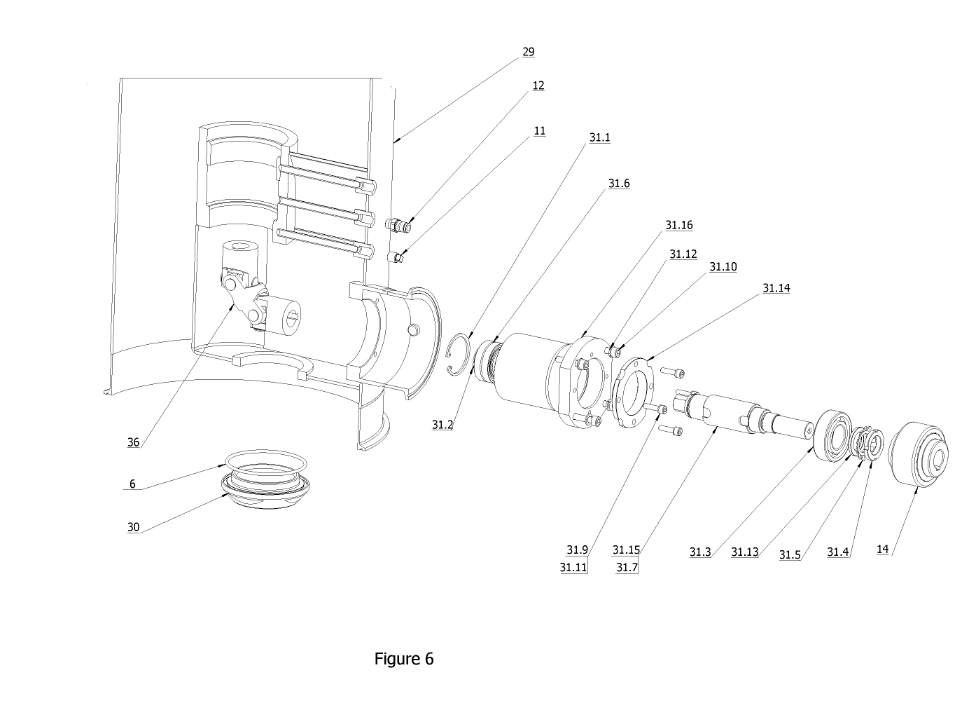

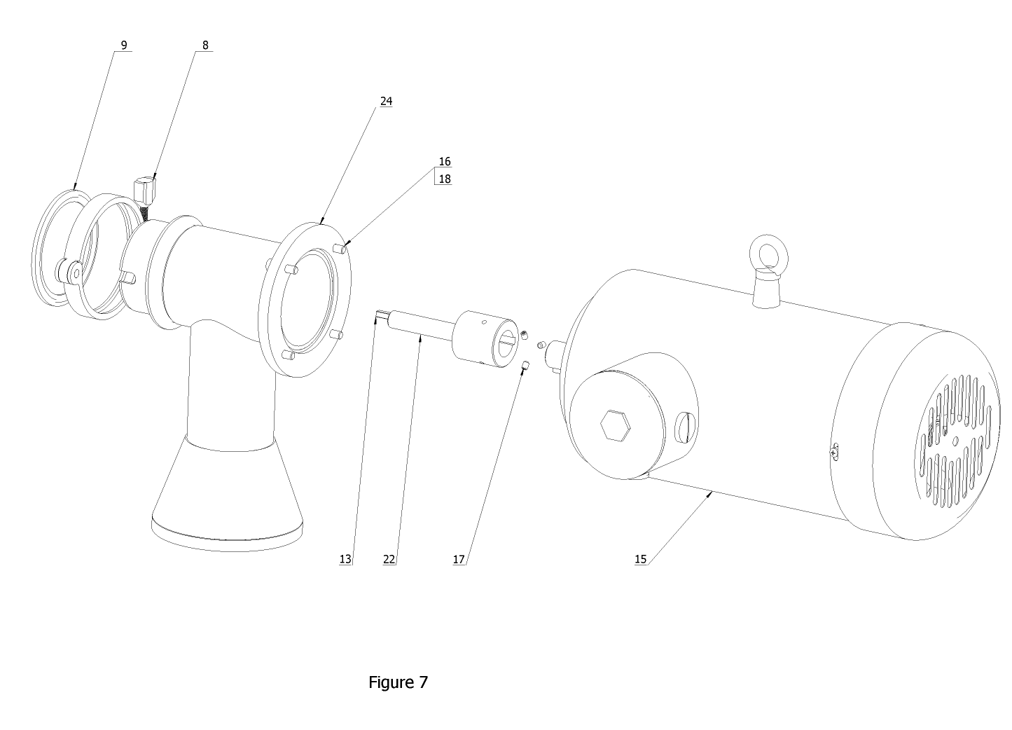

Referring first to FIGS. 1a-d and 2 there is shown a cone mill generally indicated 50.

In brief, the mill 50 comprises a milling chamber 29 and a motor 15 which are orientated at approximately 90 degrees with respect to each other.

The motor 15 drives a drive shaft 31.15, which in this embodiment is orientated to rotate along a generally horizontal axis. The milling chamber 29 includes a beater 23 which is rotatable within a conical screen 26 and is driven to do so in use by a tool drive shaft 32.13 which is orientated to rotate along a generally vertical axis. It will therefore be seen that rotational drive provided by the motor must be transferred from the shaft 31.15 to the shaft 32.13 through a right angle. In this embodiment, if the motor shaft 31.15 is rotated anti-clockwise (looking toward the mill) then the beater 23 will rotate clockwise.

The transfer the rotary motion the drive shafts 31.15, 32.13 are coupled by a double universal joint 36. The universal joints are capable of transmitting torque and rotational motion from one shaft to another when their axes are inclined to each other by some angle.

The replacement of gears with a universal joint means that lubrication on the gears is removed. All lubrication in the bearing is now contained in those components by seals, hence removing a major contamination source.

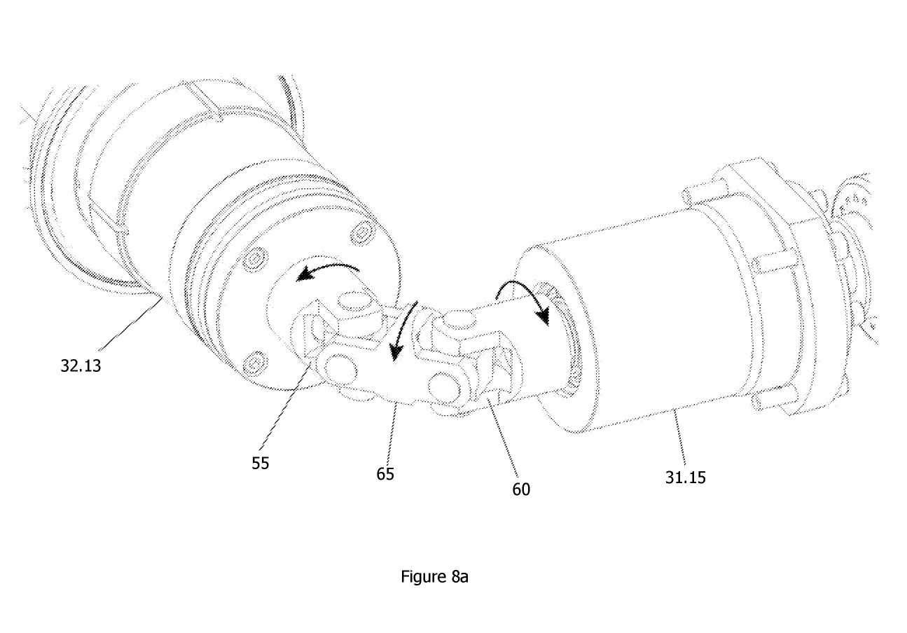

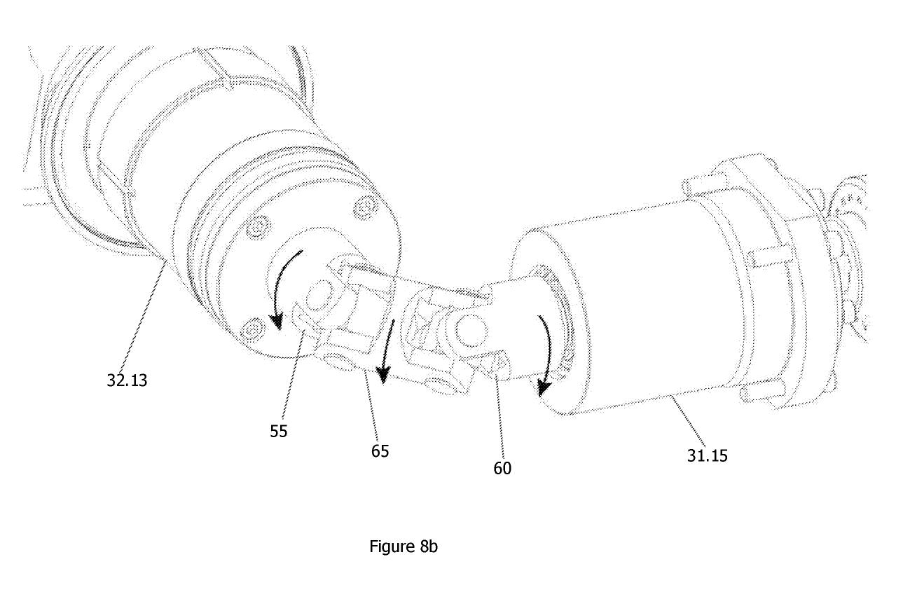

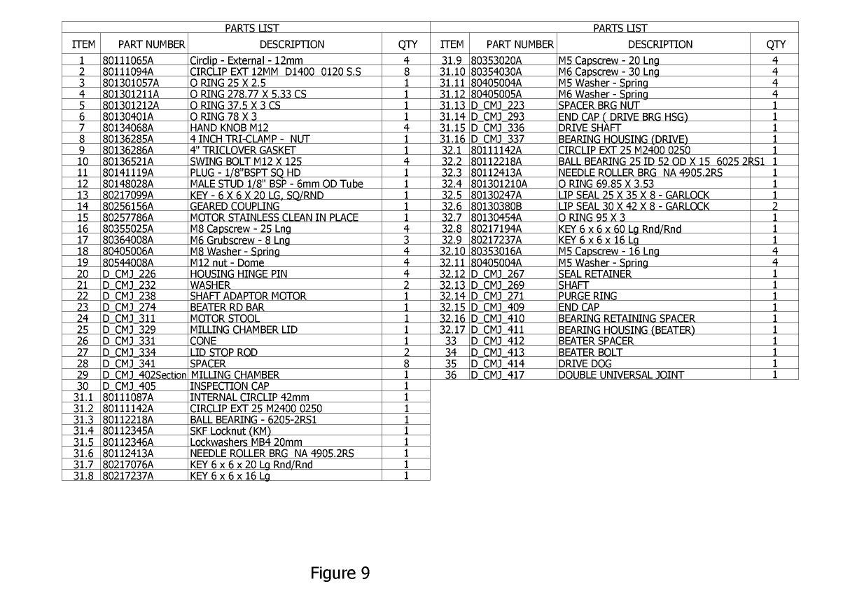

FIGS. 8a and 8b illustrate the structure and functioning of the joint 36.

The double Cardan style joint 36 consists of two universal joints 55, 60 mounted back to back with a center yoke 65.

The joint 36 effectively comprises two halves; each half having two degrees of freedom and providing 45 degrees of movement.

FIG. 8a is the starting point at which rotation is applied at the right-hand side. FIG. 8b is the joint rotated through approximately 45 degrees.

In use product is fed from above the chamber into the conical screen. Rotation of the beater causes product to be moved across the screen by the beater arms. The action of the beater breaks product down into smaller particles until it can fall through the screen. The material falls through the chamber 29 and out of the bottom.

Although illustrative embodiments of the invention have been disclosed in detail herein, with reference to the accompanying drawings, it is understood that the invention is not limited to the precise embodiments shown and that various changes and modifications can be effected therein by one skilled in the art without departing from the scope of the invention as defined by the appended claims and their equivalents.

Thus, the present invention is well adapted to carry out the objectives and attain the ends and advantages mentioned above as well as those inherent therein. While presently preferred embodiments have been described for purposes of this disclosure, numerous changes and modifications will be apparent to those of ordinary skill in the art. Such changes and modifications are encompassed within the spirit of this invention as defined by the claims.

What is claimed is:

1. A cone mill comprising a rotating tool for moving friable material across a static conical screen, the tool being driven to rotate by a tool drive shaft, the mill includes a motor, the motor causing rotation of a motor drive shaft, the tool drive shaft and the motor drive shaft being located an angle with respect to each other, the mill comprising a universal joint for transferring rotary motion from the motor through the angle to the tool.

2. A cone mill as claimed in claim 1, in which the universal joint is a double universal joint.

3. A cone mill as claimed in claim 1, in which the universal joint is a double Cardan joint.

4. A cone mill as claimed in claim 1, in which the angle is in the range 90° to 125°.

5. A cone mill as claimed in claim 4, in which the angle is approximately 90°.

6. A cone mill as claimed in claim 5, in which the universal joint comprises two Cardan-style universal joints each joint providing approximately 45° of rotary angle.

7. A cone mill as claimed in claim 1, in which the rotating tool is vertically mounted.

8. A cone mill as claimed in claim 1, in which, in use, the tool drive shaft is generally vertical and the motor drive shaft is generally horizontal.

9. A cone mill as claimed in claim 1, in which the tool is a beater.

10. A cone mill as claimed in claim 1, in which the cone diameter is approximately: 680 mm, 540 mm, 340 mm, 220 mm, 170 mm, 120 mm or 75 mm.

11. A pharmaceutical powder milling machine comprising a cone mill as claimed in claim 1.

12. A cone mill drive shaft coupling comprising a universal joint for transferring rotary motion from a motor through an angle to a milling tool.

13. A cone mill drive shaft comprising two rotatable shaft sections, the sections being positioned at an angle with respect to each other, the shaft comprising a coupling for transferring rotary motion through the angle in use, the coupling comprising a universal joint.

14. A cone mill comprising a rotating tool for moving friable material across a static conical screen, the tool being driven to rotate by a tool drive shaft, the mill includes a motor, the motor causing rotation of a motor drive shaft, the tool drive shaft and the motor drive shaft being located at an approximately 90 degree angle with respect to each other, the mill comprising a gearless joint for transferring rotary motion from the motor through the angle to the tool, said gearless joint comprising a double universal joint having a first joint and a second joint, each of said joints providing approximately 45 degrees of rotary angle of said 90 degrees between said motor drive shaft and said tool drive shaft.

15. A cone mill as claimed in claim 14, in which the first and second joints are Cardan-style universal joints.

16. A cone mill as claimed in claim 14, in which the first and second joints are mounted back-to-back with a center yoke, said first joint being connected, directly or indirectly, to said motor drive shaft, said second joint being connected, directly or indirectly, to said tool drive shaft.
